(19) United States
(12) Patent Application Publication
(10) Pub. No.: US 2025/0165769 A1
(43) Pub. Date: May 22, 2025

(54) UTILIZATION-BASED MAPPING FOR THREE DIMENSIONAL ANALOG IN-MEMORY COMPUTING

(71) Applicant: INTERNATIONAL BUSINESS MACHINES CORPORATION, ARMONK, NY (US)

(72) Inventors: Athanasios Vasilopoulos, KIlchberg (CH); Julian Röttger Büchel, Zurich (CH); Manuel Le Gallo-Bourdeau, Horgen (CH); Irem Boybat Kara, Adliswil (CH); Abbas Rahimi, Zurich (CH); Abu Sebastian, Adliswil (CH)

(21) Appl. No.: 18/513,491

(22) Filed: Nov. 17, 2023

(51) Int. Cl. G06N 3/08; G06N 5/04

(52) U.S. Cl. CPC G06N 3/08; G06N 5/04

(57) ABSTRACT

A method for balancing utilization of tiles in an analog in-memory computing system includes identifying, by a computer processor, a plurality of tiles in the analog in-memory computing system. The computer processor receives a plurality of layers in a neural network being processed by the analog in-memory computing system. The computer processor maps the plurality of layers in the neural network to the plurality of tiles. The computer processor determines a number of operations for each of the tiles in the plurality of tiles. The computer processor determines an equalized utilization rate for the tiles in the plurality of tiles. In addition, the computer processor assigns the layers to the plurality of tiles. The tiles are assigned so that a first utilization rate of a first tile is balanced relative to a second utilization rate of a second tile in the analog in-memory computing system.

### BACKGROUND

### Technical Field

The present disclosure generally relates to Deep Neural Network model accelerators, comprising a plurality of 3-Dimensional in-memory compute tiles, and more particularly to methods for assigning the parameters of the model in the memory devices of the tiles.

### Description of the Related Art

Analog In-Memory Computing (AIMC) is a promising Non-Von Neumann architecture for Deep Learning (DL) inference tasks. It is an example of a weight stationary architecture, which can perform Multiply-Accumulate (MAC) operations in-place (in-memory), without the need to shuffle data between memory and processing unit. An important limiting factor of weight stationary architectures is memory capacity, as each weight is saved separately (no weight reuse).

AIMC using 3-Dimensional (3D) memory devices is a candidate to alleviate this constraint. It increases the weight capacity of the system by scaling the memory cells vertically. It can extend capacity in the order of billions of neural network parameters. The increased number of parameters can be used to either fit modern models that exceed a billion parameters or to fit multiple models in the same system.

A 3D AIMC system comprises a plurality of elementary 3D AIMC computational units, referred to as “tiles”, which include multiple “tiers,” that represent 2D slices of a tile. A Matrix-Vector Multiply (MVM) operation on a tile can be performed by selecting one tier at a time. This mode of operation introduces a unique resource constraint on the usage of the tile, making parallel computation or model pipelining a challenging task.

One conventional method maps a single model on a 3D AIMC system. The conventional method aims to reduce latency and increase throughput. In the conventional method, Di sequential layers are mapped to each tile of the system. The parameter Di can vary per-tile and is selected to minimize max (tᵢ), where tᵢ comprises a latency of an in-memory tile i, the latency t computed according to: tᵢ>Σtᵢⱼ, where tᵢⱼ denotes the latency of utilized tier j within that tile, and where max (tᵢ) denotes the highest such tᵢ found among all in-memory tiles i storing a 2D weight-matrix representing at least a portion of the N neural network model layers. The conventional art may be suitable for networks where layers are configured to have uniform execution times (for example, each weight array is used the same amount).

### SUMMARY

According to an embodiment of the present disclosure, a computer program product for balancing utilization of tiles in an analog in-memory computing system includes one or more computer readable storage media, and program instructions collectively stored on the one or more computer readable storage media. The program instructions include identifying, by a computer processor, a plurality of tiles in the analog in-memory computing system. The computer processor receives a plurality of layers in a neural network being processed by the analog in-memory computing system. The computer processor maps the plurality of layers in the neural network to the plurality of tiles. The computer processor determines a number of operations for each of the layers in the plurality of layers. The computer processor determines an equalized utilization rate for the tiles in the plurality of tiles. In addition, the computer processor assigns the layers to the plurality of tiles. The layers are assigned so that a first utilization rate of a first tile is balanced relative to a second utilization rate of a second tile in the analog in-memory computing system.

According to an embodiment of the present disclosure, a method for balancing utilization of tiles in an analog in-memory computing system include identifying, by a computer processor, a plurality of tiles in the analog in-memory computing system. The computer processor receives a plurality of layers in a neural network being processed by the analog in-memory computing system. The computer processor maps the plurality of layers in the neural network to the plurality of tiles. The computer processor determines a number of operations for each of the layers in the plurality of layers. The computer processor determines an equalized utilization rate for the tiles in the plurality of tiles. In addition, the computer processor assigns the layers to the plurality of tiles. The layers are assigned so that a first utilization rate of a first tile is balanced relative to a second utilization rate of a second tile in the analog in-memory computing system.

According to an embodiment of the present disclosure, a computing device configured to balance utilization of tiles in an analog in-memory computing system includes a processor operating an analog in-memory computing engine in the analog in-memory computing system and a memory coupled to the processor. The memory stores instructions causing the processor to perform acts including identifying, by a computer processor, a plurality of tiles in the analog in-memory computing system. The computer processor receives a plurality of layers in a neural network being processed by the analog in-memory computing system. The computer processor maps the plurality of layers in the neural network to the plurality of tiles. The computer processor determines a number of operations for each of the tiles in the plurality of tiles. The computer processor determines an equalized utilization rate for the tiles in the plurality of tiles. In addition, the computer processor assigns the layers to the plurality of tiles. The tiles are assigned so that a first utilization rate of a first tile is balanced relative to a second utilization rate of a second tile in the analog in-memory computing system.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a computing environment for utilization-based mapping of analog in-memory computing, consistent with an illustrative embodiment.

FIG. 2 is a block diagram of an architecture for utilization-based mapping of analog in-memory computing in a neural network, consistent with an illustrative embodiment.

FIG. 3 is a flowchart of a process of utilization-based mapping of analog in-memory computing in a neural network, consistent with an illustrative embodiment.

FIG. 4 is a block diagram of a neural network, consistent with an illustrative embodiment.

FIG. 5A is a diagrammatic view of a conventional layer mapping scheme of layers belonging to a neural network in a 3D AIMC system comprising two tiles.

FIG. 5B is a diagrammatic view of a layer mapping scheme of layers belonging to a neural network in a 3D AIMC system comprising two tiles, according to an embodiment.

FIG. 6A is a diagrammatic view of a layer mapping scheme of layers belonging to a neural network in a 3D AIMC system comprising two tiles, consistent with the embodiment of FIG. 5B.

FIG. 6B is a diagrammatic view of a layer mapping scheme of layers belonging to a neural network in a 3D AIMC system comprising two tiles, incorporating a locality constraint, according to an embodiment.

FIG. 7 is a block diagram of a process for placement of tiles in a neural network, consistent with an illustrative embodiment.

FIG. 8 is a diagrammatic view of a layer mapping scheme of layers belonging to multiple neural networks in a 3D AIMC system comprising three tiles, according to an embodiment.

FIG. 9 is a flowchart of a process for assigning a plurality of models in planar regions of a 3D AIMC system, based on the probability of activation to maximize parallelism, according to an embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Definitions

Neural network, as used herein, refers to a computational learning system that uses a network of functions to understand and translate a data input of one form into a desired output.

Analog In-Memory Computing (AIMC), as used herein, refers to a computing paradigm in which memory devices, used in an analog manner, are used to encode data and to perform part or the whole computation associated with a workload (for example, a neural network).

AIMC system, as used herein, refers to a software operable system that comprises analog and possibly digital circuitry and executes computations according to the AIMC paradigm.

Token, as used, herein refers to a data input (for example, an image or section of an image) to be processed using artificial intelligence.

Tile, as used, herein refers to non-volatile memory cells in a two-dimensional or three-dimensional array that include transistors or other circuit devices that control the reading and writing of the non-volatile memory cells. In some embodiments, the transistors/circuit devices perform matrix-vector multiple operations.

Tier, as used, herein refers to a two-dimensional slice of a tile.

Two-Dimensional Slice, as used, herein refers to a selected level of a three-dimensional memory array. For example, the memory array of a tile may be of size 512 by 512 and have 64 such levels. A two-dimensional slice is one of these levels that corresponds to a single 512 by 512 array.

Locality Constraint, as used, herein refers to a constraint used during optimization to enforce a heuristic (for example, a sequential layer heuristic or a “keep things close” heuristic enforced during placement).

Balance or Balanced, as used herein, refers to distributing a utilization rate, and/or a latency, and/or another characteristic of layers in a neural network so that the value of the utilization rate, latency, or other characteristic is equal or approximately evenly distributed across tiles of the system.

### Overview

The present disclosure generally relates to neural networks and more specifically, utilization-based weight mapping methods for 3D AIMC systems. The method disclosed herein improves performance in network systems where utilization varies between layers (convolutional neural network (CNN), Mixture-of-Experts transformers, and general encoder-decoder network topologies). In one aspect, the methods disclosed herein may provide advantages to neural networks where layers present significantly different execution times, due to different utilization rates (CNNs, Mixture of Experts Transformers, and Encoder-Decoder networks). A limitation of the tiles of a 3D AIMC system is that even though the memory array contains multiple tiers, only a single tier can be active at a time (single tier constraint), a limitation imposed by the device technology (e.g., NAND FLASH) and the shared periphery circuits (e.g., data converters). Due to the single tier constraint of three-dimensional AIMC tiles, network parameter allocation, also referred to as weight mapping, may have a significant effect on neural network system performance in terms of throughput and latency. Naïve or random mapping approaches generate a lot of contention in the system, creating stalls in the dataflow, which translate to decreased throughput, increased latency and scratchpad memory requirements.

Under the subject technology, an informed weight mapping method may have the following effects in the following use case applications. When the system includes a single neural network model, the methods disclosed herein reduce contention, generate less stalls in the dataflow, and increase throughput, while reducing latency.

When the system includes multiple neural network models, (in addition to the effects within a model, mentioned in point for single model systems), the teachings disclosed herein provide an informed mapping method that can have additional effects in the following listed use cases. When an input token is only consumed by a single neural network model, the teachings remove contention across models as the models process their respective inputs at different stages of their dataflow. In cases where an input may be consumed by multiple models simultaneously, the teachings maximize the parallelism across models as the models process the same input sequence.

In some embodiments, the teachings are able to provide the above effects by equalizing the utilization rate of the tiles in a neural network. As will be appreciated, the teachings herein provide a benefit to the field of computer processing by increasing throughput and decreasing latency in 3D AIMC systems. In some embodiments, the neural network operates under one or more architecture-specific restraints. The tiles may be reconfigured so that a determined utilization rate may be balanced among tiles, under architecture-specific constraints, imposed by the data communication fabric and the spatial allocation of the units in the system. For example, the number of operations or the time cost of operations may be re-distributed so that the utilization rate of tiles is equal (or nearly equal). The methods disclose herein may be usable for heterogeneous architectures where the tiles co-exist with digital processing units (DPU) to perform the auxiliary operations of networks. Embodiments may also apply the equalization of utilization rate to systems hosting more than one neural network model.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing neural network processes and in particular, the processes associated with redistributing tile operations discussed herein can be more complex than information that could be reasonably be processed manually by a human user.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one or more storage devices that may include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 includes an example of an environment for the execution of at least some of the computer code involved in performing the inventive methods, such as the improved AIMC mapping code 200. The improved AIMC mapping code 200 may include an AIMC mapping engine 240 that determines how operations among tiles in a neural network are to be distributed (or re-distributed) to balance out the workload. The AIMC mapping engine 240 may operate according to one or more of the methods disclosed in further detail below. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

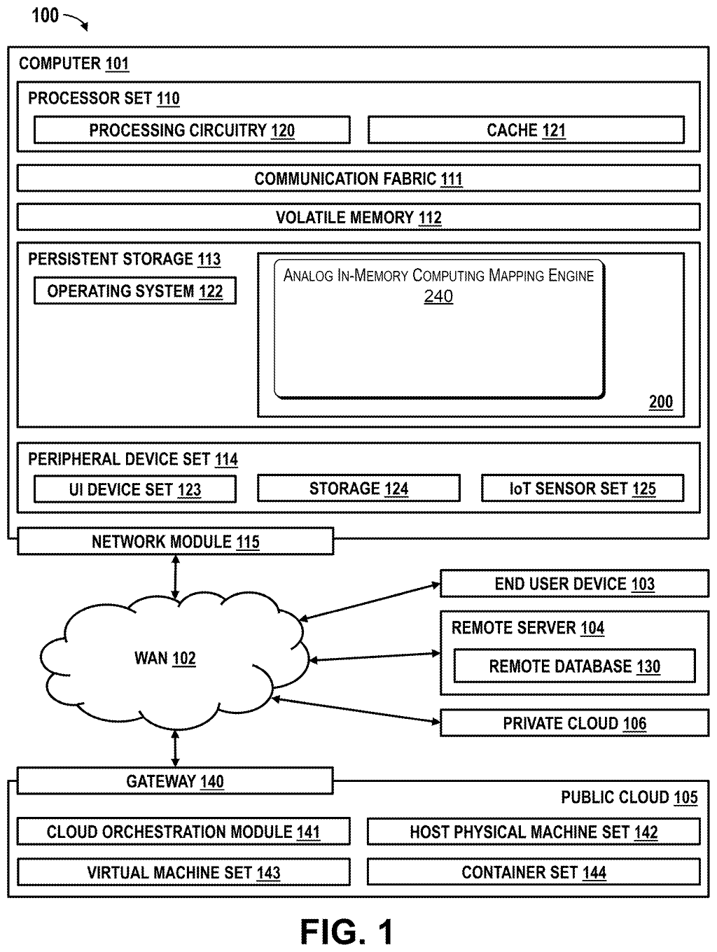

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. For the instant disclosure, the processor set 110 includes for example a central processing unit (CPU) and an accelerator. In some embodiments, a different type of processing element may be used instead of the CPU, (for example, a GPU or other process dedicated/specialized unit). Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.”

In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System Architecture

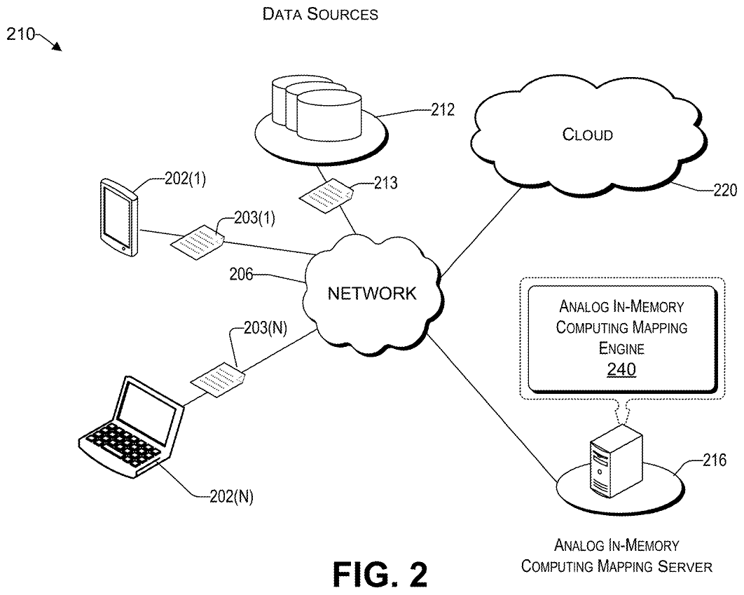

FIG. 2 illustrates an example architecture 210 for mapping the utilization of tile operations in a neural network. Architecture 210 includes a network 206 that allows various computing devices 202(1) to 202(N) to communicate with each other, as well as other elements that are connected to the network 206, such as data source 212, an AIMC mapping server 216, and the cloud 220. In some embodiments, the data source 212 may include stored cookies, login credentials, authentication files, and the software applications associated with each of the aforementioned stored files. The computing devices 202(1) to 202(N) and AIMC mapping server 216 may operate under the computing environment described above in FIG. 1. The AIMC mapping server 216 may operate the code 200, including the module for the AIMC mapping engine 240.

The AIMC mapping engine 240 may be configured to generate a neural network in the AIMC mapping server 216. As will be described in more detail below, the AIMC mapping engine 240 may determine how to map the layers of a neural network in the tiles of a three-dimensional AIMC system.

The network 206 may be, without limitation, a local area network (“LAN”), a virtual private network (“VPN”), a cellular network, the Internet, or a combination thereof. For example, the network 206 may include a mobile network that is communicatively coupled to a private network, sometimes referred to as an intranet that provides various ancillary services, such as communication with various application stores, libraries, and the Internet. The network 206 allows the AIMC mapping engine 240, which is a software program running on AIMC mapping server 216, to communicate with the data source 212, computing devices 202(1) to 202(N), and/or the cloud 220, to provide data processing. The data source 212 may include source data being processed for inference and operations to be used in processing the source data, that will be processed under one or more techniques described here. In some embodiments, a data packet 213 may be received by the AIMC mapping engine 240. This data packet 213 can be received by the AIMC mapping engine 240 by either a push operation from the data source 212 or from a pull operation of the AIMC mapping engine 240. In one embodiment, the data processing is performed at least in part on the cloud 220.

For purposes of later discussion, several user devices appear in the drawing, to represent some examples of the computing devices that may be the source of data being analyzed depending on the task chosen. Aspects of the symbolic sequence data (e.g., 203(1) and 203(N)) may be communicated over the network 206 with the AIMC mapping engine 240 of the AIMC mapping server 216. Today, user devices typically take the form of portable handsets, smart-phones, tablet computers, personal digital assistants (PDAs), and smart watches, although they may be implemented in other form factors, including consumer, and business electronic devices. While the data source 212 and the AIMC mapping engine 240 are illustrated by way of example to be on different platforms, it will be understood that in various embodiments, the data source 212 and the AIMC mapping server 216 may be combined. In other embodiments, these computing platforms may be implemented by virtual computing devices in the form of virtual machines or software containers that are hosted in a cloud 220, thereby providing an elastic architecture for processing and storage.

### Example Methodology

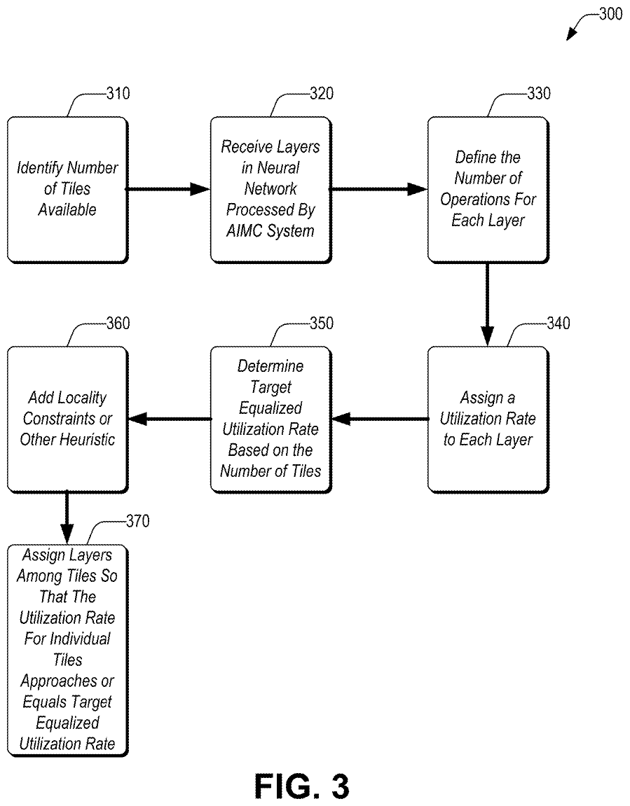

FIG. 3 shows a method 300 of mapping tile operations in an AIMC system according to an embodiment. In general, and as will be described in more detail in the figures that follow, the method 300 uses a utilization-based process to distribute the utilization workload among tiles in the AIMC system. The method 300 may be generally performed by a computing processor unless otherwise noted. In one embodiment, the method 300 is used by the AIMC engine 240 to optimize a configuration for the AIMC system. The method 300 may begin by identifying tiles being used by the AIMC system to process the neural network data, in block 310. The layers in the neural network may be received by the computer processor in block 320. The processor may define the number of operations performed by each layer, in block 330. The processor may assign a utilization rate to each layer in block 340. The processor may determine a target utilization rate based on the number of tiles in the AIMC system, in block 350. The target tile utilization rate may be defined as U_{target}=1/N, where N is the number of tiles. The layers may be assigned to the tiles such that the sum of Mean Squared Errors (or a similar loss function) between the target utilization and the tile utilization is minimized. The following equation provides an example computation for determining a utilization rate.

$$minimize Z = {\sum }_{i = 1}^{N} {( {U}_{{tile}_{i}} - {U}_{target} )}^{2}$$

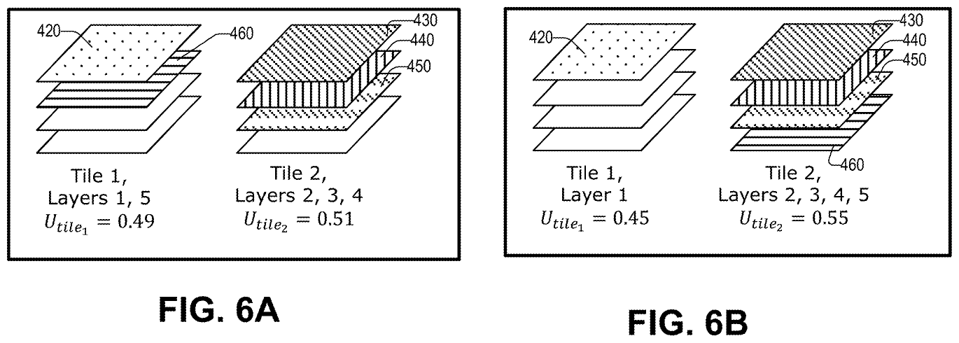

For example, in one simplified approach, the total utilization for a network may be divided by the number of tiles to provide the equalized utilization rate. In a neural network processed by two tiles, the equalized utilization rate may be approximately 50%. Some embodiments may add locality constraints or another heuristic to be considered (block 360). Locality constraints may affect the mapping so that layers are mapped to tiles in a manner that deviates somewhat from being completely equal in utilization but maintains a balanced distribution of utilization (see for example, the description related to FIG. 6B below). For example, when a computer processor operating the AIMC mapping engine 240 receives a locality constraint, the layers may be assigned to the tiles based partly on the locality constraint, but generally prioritizing the distribution of tile utilization. For example, some embodiments may include selecting the locality constraint based on reducing latency in an output of the neural network. Yet, in other embodiments, a selected locality constraint may result in increasing the latency of a neural network in exchange for higher efficiency or other quantities. Layers may be assigned to tiles so that the utilization rate for individual tiles approaches or is equal to the targeted equalized utilization rate. When the utilization rate for tiles is not equal due to the effect of locality constraints or (another heuristic), the processor may still attempt to balance the utilization rate for tiles as close to equal as possible given the constraint(s).

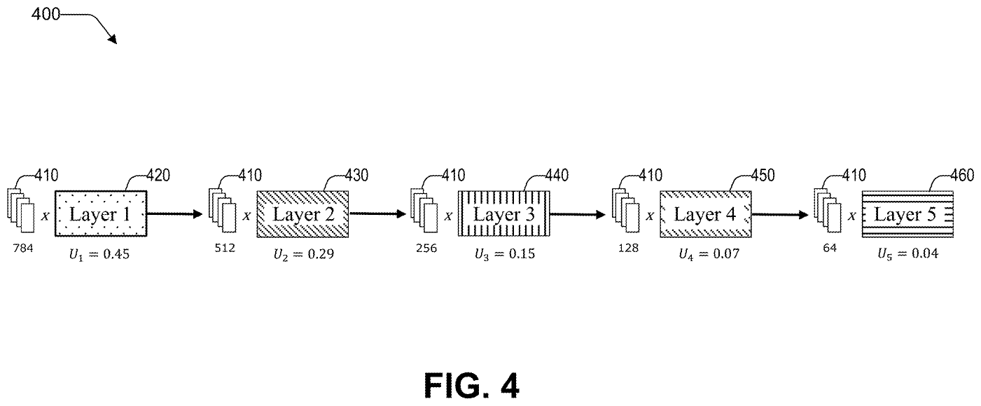

FIG. 4 shows a representation of a neural network architecture 400. The neural network architecture 400, includes a plurality of layers (420, 430, 440, 450, and 460). The number of operations 410 to be performed by each layer may differ. For example, each layer (420, 430, 440, 450, or 460) is used a different number of times for one input token (for example, an image provided to the neural network for analysis). The token may be considered a task (or operation 410) worked on by each layer (420, 430, 440, 450, and 460). The utilization (U) of a layer is defined as the operations of a layer normalized to the total network operations for one input token.

Operations in this example refer to the Matrix-Vector Multiply operations. The following equation may be used to define utilization for a layer:

$${U}_{i} = \frac{{OPS}_{i}}{{\sum }_{l ∈ L} {OPS}_{l}} , where L = \{ all network layers \}$$

As can be seen in the neural network architecture 400, the utilization distribution is 45% for layer 420, 29% for layer 430, 15% for layer 440, 7% for layer 450, and 4% for layer 460.

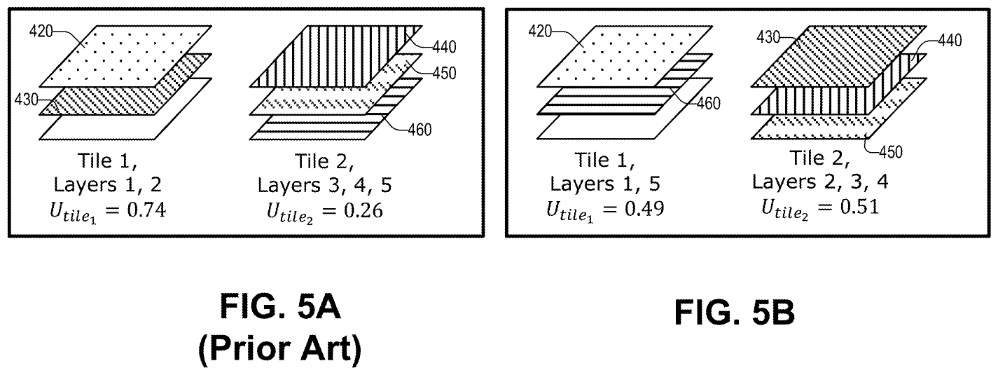

FIGS. 5A and 5B show a juxtaposition of mapping techniques. FIG. 5A shows a mapping technique for neural network layers according to a conventional approach. FIG. 5B shows a utilization-based mapping scheme for a neural network according to an embodiment of the subject technology. In FIGS. 5A and 5B, the layers 420, 430, 440, 450, and 460 in FIG. 4 and their associated utilization rates are used to provide a comparison of utilization efficiency. In addition, the layers 420, 430, 440, 450, and 460 are mapped into tiles that comprise one or more layers (420, 430, 440, 450, or 460). For the comparison in FIGS. 5A and 5B, the image is being processed by two 3D-AIMC tiles. In FIG. 5A, the first tile includes layers 420 and 430, which in aggregate, have a utilization rate of 74%. The second tile includes layers 440, 450, and 460, which have a total utilization rate of 26%.

In FIG. 5B, the tiles are mapped using a method of the subject technology that redistributes the utilization to balance the workload performed by the layers (420, 430, 440, 450, and 460). In some embodiments, the workloads are distributed to provide an equal or near equal utilization rate between tiles. In one embodiment, assigning the layers to the tiles, may include determining a first aggregate utilization rate for layers in a first tile in the neural network, balanced relative to a second aggregate utilization rate for layers in a second tile in the neural network. For example, as shown in FIG. 5B, the layers are distributed so that layers 420 and 460 are now mapped to the first tile. The aggregate utilization rate for the first tile (“Tile 1”) that includes layers 420 and 460 equals 49%. Layers 430, 440, and 450 are now mapped to the second tile (“Tile 2”). The aggregate utilization rate for Tile 2 that includes layers 430, 440, and 450 is equal to 51%. The mapping scheme results in a utilization rate of 49% for the first tile and a utilization rate of 51% for the second tile.

As will be understood, a neural network's throughput is determined by its slowest pipeline stage. In a 3D system, where all layers mapped to a tile are executed sequentially, each tile may be considered a separate stage of a pipeline. That means that a pipeline stage time is defined as the time that is needed such that all active tiles process their inputs on all their active tiers.

In the method shown in FIG. 5A, the pipeline stage time is determined by the usage of the first tile, where 74% of the operations take place. In comparison, the proposed method shown in FIG. 5B, has a pipeline stage time determined by the second tile, where 51% of the operations take place. This difference means that pipeline stages shown in FIG. 5B can be faster (0.51*totalOPS*t_{OP}<0.74*totalOPS*t_{OP}) and thus throughput will be increased (where totalOPS is the total network operations and t_{OP} is the operation time (MVM)).

Latency, may be defined as the time the system needs to produce an output. Latency may be calculated as the number of pipeline stages an input must go through multiplied by the pipeline stage time. The proposed method shown in FIG. 5B has worse latency than the method shown in FIG. 5A. This happens because the non-successive mapping of the proposed method in FIG. 5B results in an additional pipeline stage an input must go through, namely Tile 1 (the first tile) for layer 420, Tile 2 (the second tile) for layers 430, 440, and 450, and back again to Tile 1 for layer 460. So, the latency calculation would be (0.51*totalOPS*t_{OP}*3>0.74*totalOPS*t_{OP}*2). In the following embodiments, different variations of the utilization-based mapping will be presented, that can be employed to optimize various criteria under various use cases.

For example, another aspect of the subject method includes considering the staging requirements. The staging requirements can be thought of as the number of activations that must be stored so that all tiers in the tile can execute their respective “piece of work” in a pipeline stage. If successive layers are mapped in a tile, the activations that layer X+1 needs to perform its operations will be created by layer X in the same tile and thus the activations don't need to be staged. “Successive” in this regard refers to layers being identified in a sequential order (for example, “layer 1”, “layer 2”, etc.). As will be appreciated, equalizing the utilization of tiles achieves equal distribution of the staging requirements across the system, as all tiles need to perform similar amounts of total work in any given stage. Nevertheless, tuning the “piece of work” size, such that all tiles are able to stage the corresponding amount of data, is helpful before moving to execution.

In some embodiments, memory usage of a given system may be optimized to yield the maximal computation efficiency. Optimization also includes optimizing how outgoing activations are sent to the staging memory of the following tile during the execution of the pipeline stage. The physical placement of tiles may also play a significant role in an efficient execution of a network using the subject technology.

### Locality Constraints

Referring now to FIGS. 6A and 6B, an embodiment showing the effect of including a locality constraint in the system is shown. A “locality constraint” is a constraint inserted into an algorithm during optimization to “guide” the algorithm. The constraints may sometimes produce worse but more feasible solutions. For example, even though the split of 51%-49% is more equal than that of 55%-45%, the distribution requires more data movement across tiles. To include such considerations in an outcome, constraints may be included during optimization. FIG. 6A shows the embodiment of mapping provided by the method described for FIG. 5B. FIG. 6B shows mapping of neural network layers in a set of tiles based on the inclusion of a locality constraint. For example, a locality constraint for layers mapped in tiers of a set of tiles may include that tiles can only have successive sequences of layers. The original utilization-based mapping for equalized distribution of workload may be maintained in addition to the locality constraint. The example constraint reduces the number of pipeline stages an input must pass through and reducing the dataflow complexity, imposing an one-way-only dataflow. A result of applying the example locality constraint to layers (420, 430, 440, 450, and 460) under the utilization-based mapping process of the subject technology is shown in FIG. 6B where layer 420 is mapped to the first tile and layers 430, 440, 450, and 460 are mapped to the second tile. As can be seen, the utilization rate for the first tile has changed from 49% to 45%. The utilization rate for the second tile has changed from 51% to 55%. So, while the distribution of utilization is now farther from being equally distributed, other performance factors are affected that may yet be beneficial to the operation of the neural network.

For example, as shown in FIG. 6A, the embodiment has a smaller pipeline stage time (0.51<0.55). However, FIG. 6B which includes the locality constraint defined above shows decreased latency, since this mapping scheme has only two pipeline stages (0.55*2<0.51*3). The mapping scheme in FIG. 6B also presents simpler dataflow, which includes always proceeding from the first tile to the second tile, without the need for two-way communication (i.e., processing back and forth between tiles).

Adding a locality constraint to the utilization-based mapping process may also affect the specifications of the system, (for example, the I/O, the communication system, etc.).

Some indicative constraints may include for example: placing the tiles containing the first and last layers near the input and output buffers respectively; or placing tiles with successive layers close to each other to reduce communication costs. Depending on the communication system (for example, mesh communication fabric vs. bus communication fabric), placing tiles with successive layers close to each other can have different results. For example, a mesh communication fabric is a very versatile communication fabric that can be used by multiple tiles at the same time as long as the paths of the signals are not intercepting. A bus communication fabric is a more restrictive system where only one tile can send data at a time across the system. These two have different implications when it comes to communication costs.

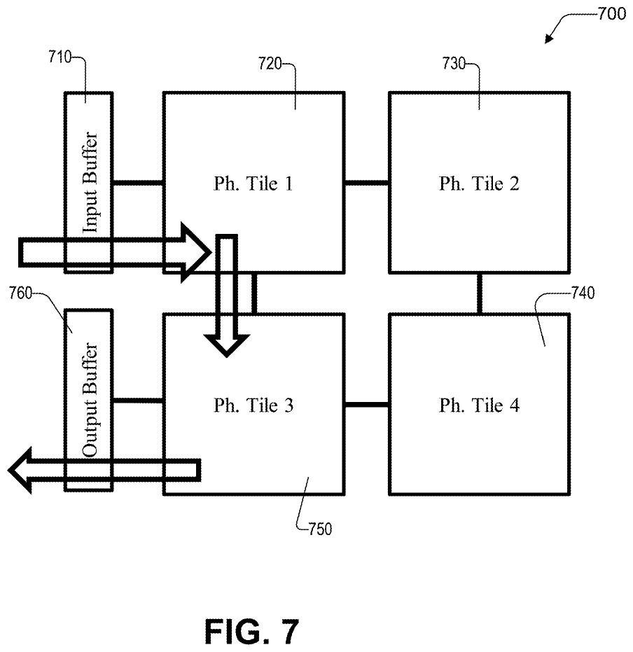

Referring to FIG. 7 as an example, a 4-tile system 700 is shown with a communication fabric and I/O buffers 710 and 760. The communication costs in this system are equal to the steps between nodes represented by physical tiles 720, 730, 740, and 750 (i.e., no diagonals, tile 720 to tile 730 has a cost value of 1; tile 720 to tile 740 has a cost value of 2). In the system 700, the optimal placement would be to place the first tile of FIG. 6B in the physical tile 720 position and the second tile of FIG. 6B in the physical tile 750 position. That placement would result in minimum data movement and thus communication costs.

### Heterogenous Systems

Some embodiments include a neural network using a heterogeneous system. In a heterogenous system of the subject technology, AIMC tiles may be operated in conjunction with digital processing units (DPU), that are used to perform auxiliary operations between some or all of the network layers. In some embodiments, the utilization-based mapping processes described above may be adapted for compatibility with heterogenous systems. If the digital compute between layers is neglected, a DPU's processing time can exceed the time of the pipeline stage time, breaking the pipeline and decreasing throughput. Also, if a sequence of layers that need intermediate DPU processing are mapped far from a DPU unit, communication costs and communication contention is increased, potentially hindering performance. In models that need intermediate DPU processing, the following may be considered. If only one DPU exists in the system, the locality constraint (for example embodiments described with respect to FIG. 6B) may be extended to include that tiles close to the DPU may contain layers that frequently use the DPU. If multiple DPUs exist in the system, first, the processing load of DPUs may be equalized as discussed in previous embodiments, and then tiles near a DPU may contain layers that frequently use that DPU. In one embodiment, a method may include mapping a plurality of layers belonging to a plurality of neural networks to one or more two-dimensional tiers on one or more tiles in a heterogeneous three-dimensional compute-in-memory accelerator with one or more digital processing units, such that all units (digital processing units (DPUs) or AIMC tiles) in the system present equal processing load and units are spatially placed such that communication costs are minimized.

### Multiple Models

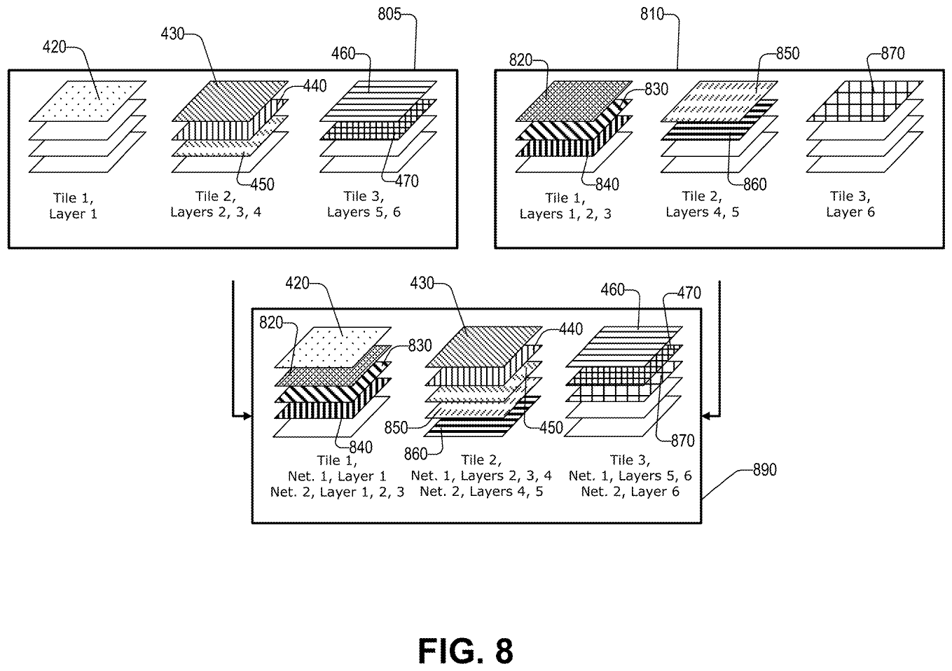

Referring now to FIG. 8, an embodiment showing utilization-based mapping in a system where multiple neural network models are present is shown according to an embodiment. In FIG. 8, two models are integrated into the mapping of the subject technology. The models in FIG. 8 may be independent of the models disclosed in previous embodiments. For example, the models in FIG. 8 have six layers (whereas the previous models included five layers). So, while similar numbering and cross-hatching may be used in FIG. 8 that was used in earlier embodiments, there is not necessarily a reference or correlation between the layers shown in FIG. 8 to the layers depicted previously. A first model 805 uses the layers 420, 430, 440, 450, 460 and 470. A second model 810 includes layers 820, 830, 840, 850, and 860. When multiple models are present in the neural network, the embodiment shows a mapping for the case that a system hosts multiple neural networks (here two of them), where each one will always process different inputs. An example of that case could be a system that has a network processing images and one that processes sounds. At each moment, an input stimulus, (either piece of image or sound), will be processed by either network but never by both. In the above case, mapping of the two models is proposed in a 3D AIMC system as shown in FIG. 8. It should be appreciated that a system with multiple models can be extremely complex when trying to balance utilization since the models can have vastly different computational complexity and thus different rates of processing.

In one embodiment, each model (805 and 810) may be mapped in isolation. The mapping for each model (805 and 810) may use for example, the method described with respect to FIG. 6B. It should be noted that while both models (805 and 810) used the mapping process of FIG. 6B, the arrangement of layers in respective models appears different because the utilization for individual layers may differ. The models may be stacked vertically, such that all models have their Nth pipeline stage at the same planar area (or tile). For example, all the layers used in the first tile (layer 420) of the first model 805 are placed with all the layers used in the first tile (layers 820, 830, and 840) of the second model 810 into an aggregate model 890. The same stacking occurs with the layers in the second tile of all the models (805 and 810) so that second stage of the model 890 includes layers 430, 440, 450, 850, and 860. Similarly, the layers 460 and 470 in the third tile of the first model 805 may be combined with layer 870 of the third tile of the second model 810.

The proposed stacking guarantees that no contention occurs across models, since for every stage of the pipeline, only one network will be active and thus only one network will occupy the respective planar area. Using this method, the performance of every network will be limited by the slowest active network in the system and thus the method is favorable in cases where models have similar operation counts.

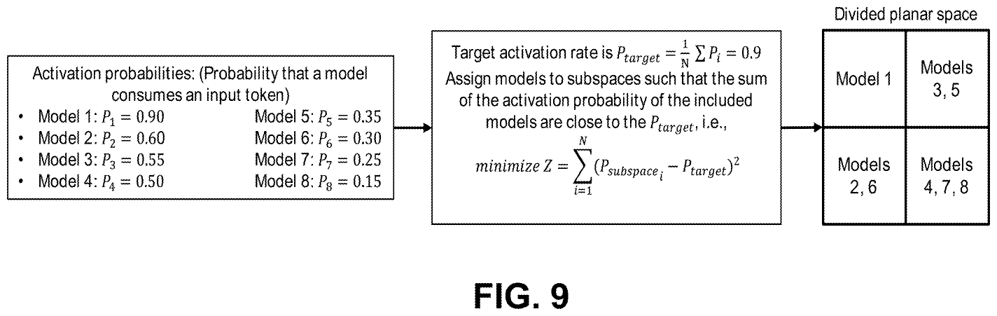

FIG. 9 is an embodiment showing utilization-based mapping in a system where multiple neural network models are present. In FIG. 9, the system hosts multiple neural network models but now multiple models can process the same or in-common input stimuli (for example, two networks will process the input image). In this case, the planar space may be divided into subspaces (N) such that there is the possibility of processing the models in parallel without conflicts. N may be selected as the mean number of co-activated models, e.g., if four models are consuming each input token, the space should be divided at least to four subspaces. Using the activation probability of the M models, the models are assigned to the subspaces, such that every subspace has an equal probability of being activated.

For example, models may be assigned to subspaces such that the sum of the activation probability of the included models are close to the target activation rate (P_{target}). In one embodiment,

$${P}_{target} = \frac{1}{N} .$$

For the example being discussed, P_{target}=0.9. Models may be assigned to subspaces such that the sum of the activation probability of the included models are close to the P_{target}. For example,

$$minimize Z = {\sum }_{i = 1}^{N} {( {P}_{{subspace}_{i}} - {P}_{target} )}^{2} .$$

After the model assignment, the models may be mapped inside each subspace using the method described in FIG. 8 (or in FIG. 6B if only one model occupies a given subspace). In the example shown, the target probability calculated is 90%. For planar spaces divided into four sections, to obtain a distribution where each subspace has a near probability of 90% activation, model 1 is positioned in its own subspace; models 3 and 5 are positioned in a second subspace;

models 2 and 6 are positioned in a third subspace; and models 4, 7, and 8 are positioned in the fourth subspace.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact.

They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer program product for balancing utilization of tiles in an analog in-memory computing system, the computer program product comprising:
one or more computer readable storage media, and program instructions collectively stored on the one or more computer readable storage media, the program instructions comprising:
identifying, by a computer processor, a plurality of tiles in the analog in-memory computing system;
receiving, by the computer processor, a plurality of layers in a neural network being processed by the analog in-memory computing system;
defining, by the computer processor, a number of operations for each layer in the plurality of layers;
assigning a utilization rate to each layer;
determining, by the computer processor, a target equalized utilization rate based on the identified plurality of tiles; and
assigning the layers to the plurality of tiles, by the computer processor, wherein a first utilization rate of a first tile is balanced relative to a second utilization rate of a second tile in the analog in-memory computing system.

2. The computer program product of claim 1, wherein:
the program instructions further comprise receiving, by the computer processor, a locality constraint; and
assigning the layers to the plurality of tiles is based at least in part on the locality constraint.

3. The computer program product of claim 2, wherein the locality constraint includes using only successive layers in the tiles.

4. The computer program product of claim 2, wherein the program instructions further comprise selecting the locality constraint based on reducing latency in an output of the neural network.

5. The computer program product of claim 1, wherein:
the neural network operates under one or more architecture-specific restraints; and
the determination of the equalized utilization rate for the tiles is made under the one or more architecture-specific restraints.

6. The computer program product of claim 1, wherein the analog in-memory computing system comprises a plurality of neural network models, and wherein the program instructions further comprise:
receiving an input token of an image for processing by the plurality of neural network models;
mapping the plurality of neural network models to a planar space;
dividing the planar space into a plurality of subspaces; and
assigning the plurality of neural network models to the subspaces, wherein an activation rate for the processing of the input token is evenly distributed amongst the subspaces.

7. The computer program product of claim 1, wherein:
the analog in-memory computing system comprises a first neural network model and a second neural network model; and
the program instructions further comprise:
stacking layers of a first tile from the first neural network model with layers of the first tile from the second neural network model into a new tile; and
determining the target equalized utilization rate for the new tile.

8. A computer implemented method for balancing utilization of tiles in an analog in-memory computing system, comprising:
identifying, by a computer processor, a plurality of tiles in the analog in-memory computing system;
receiving, by the computer processor, a plurality of layers in a neural network being processed by the analog in-memory computing system;
defining, by the computer processor, a number of operations for each layer in the plurality of layers;
assigning a utilization rate to each layer;
determining, by the computer processor, a target equalized utilization rate based on the identified plurality of tiles; and
assigning the layers to the plurality of tiles, by the computer processor, wherein a first utilization rate of a first tile is balanced relative to a second utilization rate of a second tile in the analog in-memory computing system.

9. The method of claim 8, further comprising:
receiving, by the computer processor, a locality constraint; and
wherein assigning the layers to the plurality of tiles is based at least in part on the locality constraint.

10. The method of claim 9, wherein the locality constraint includes using only successive layers in the tiles.

11. The method of claim 9, further comprising selecting the locality constraint based on reducing latency in an output of the neural network.

12. The method of claim 8, wherein:
the neural network operates under one or more architecture-specific restraints; and
the determination of the equalized utilization rate for the tiles is made under the one or more architecture-specific restraints.

13. The method of claim 8, wherein the analog in-memory computing system comprises a plurality of neural network models, and wherein the method further comprises:
receiving an input token of an image for processing by the plurality of neural network models;
mapping the plurality of neural network models to a planar space;
dividing the planar space into a plurality of subspaces; and
assigning the plurality of neural network models to the subspaces, wherein an activation rate for the processing of the input token is evenly distributed amongst the subspaces.

14. The method of claim 8, wherein:
the analog in-memory computing system comprises a first neural network model and a second neural network model; and
the method further comprises:
stacking layers of a first tile from the first neural network model with layers of the first tile from the second neural network model into a new tile; and
determining the target equalized utilization rate for the new tile.

15. A computing device configured to balance utilization of tiles in an analog in-memory computing system, comprising:
a processor operating an analog in-memory computing engine in the analog in-memory computing system; and
a memory coupled to the processor, the memory storing instructions to cause the processor to perform acts comprising:
identifying, by a computer processor, a plurality of tiles in the analog in-memory computing system;
receiving, by the computer processor, a plurality of layers in a neural network being processed by the analog in-memory computing system;
defining, by the computer processor, a number of operations for each layer in the plurality of layers;
assigning a utilization rate to each layer;
determining, by the computer processor, a target equalized utilization rate based on the identified plurality of tiles; and
assigning the layers to the plurality of tiles, by the computer processor, wherein a first utilization rate of a first tile is balanced relative to a second utilization rate of a second tile in the analog in-memory computing system.

16. The computing device of claim 15, wherein the instructions cause the processor to perform further acts comprising:
receiving, by the computer processor, a locality constraint; and
wherein assigning the layers to the plurality of tiles is based at least in part on the locality constraint.

17. The computing device of claim 16, wherein the instructions cause the processor to perform further acts comprising selecting the locality constraint based on reducing latency in an output of the neural network.

18. The computing device of claim 15, wherein:
the neural network operates under one or more architecture-specific restraints; and
the determination of the equalized utilization rate for the tiles is made under the one or more architecture-specific restraints.

19. The computing device of claim 15, wherein the analog in-memory computing system comprises a plurality of neural network models, and wherein the memory storing instructions cause the processor to perform acts further comprising:
receiving an input token of an image for processing by the plurality of neural network models;
mapping the plurality of neural network models to a planar space;
dividing the planar space into a plurality of subspaces; and
assigning the plurality of neural network models to the subspaces, wherein an activation rate for the processing of the input token is evenly distributed amongst the subspaces.

20. The computing device of claim 15, wherein:
the analog in-memory computing system comprises a first neural network model and a second neural network model; and
the instructions cause the processor to perform further acts comprising:
stacking layers of a first tile from the first neural network model with layers of the first tile from the second neural network model into a new tile; and
determining the target equalized utilization rate for the new tile.
